(19) United States
(12) Patent Application Publication
(10) Pub. No.: US 2017/0124848 A1
(43) Pub. Date: May 4, 2017

(54) IMAGE-BASED REMOTE OBSERVATION AND ALARM DEVICE AND METHOD FOR IN-CAR MOVING OBJECTS

(71) Applicant: Leauto Intelligent Technology (BEIJING) Co. Ltd., Beijing (CN)

(72) Inventor: Xun Zhou, Beijing (CN)

(21) Appl. No.: 14/981,625

(22) Filed: Dec. 28, 2015

(30) Foreign Application Priority Data
Nov. 2, 2015 (CN) 201510732911.8

(51) Int. Cl. G08B 21/22; G08B 21/02; G06K 9/00

(52) U.S. Cl. CPC G08B 21/22; G06K 9/00838; G08B 21/028; G08B 21/0208

(57) ABSTRACT

Embodiments of image-based remote observation and alarm device and method for in-car moving objects are disclosed. In some embodiments, the device comprises: an image acquisition module, used for acquiring real-time scene pictures of the space inside a car to generate real-time scene image data, and transmitting the real-time scene image data to an image processing and moving object detection module; the image processing and moving object detection module, used for performing pre-processing and moving object detection analysis on the real-time scene image data, and sending the detection result to an alarm module when detecting a moving object in the space inside the car; and the alarm module, used for receiving the detection result sent by the image processing and moving object detection module, generating an alarm signal and transmitting the alarm signal to a networking terminal in real time.

### CROSS-REFERENCE TO RELATED APPLICATIONS

This application claims the benefit of Chinese Patent Application No. 201510732911.8, filed on Nov. 2, 2015, and which is hereby incorporated by reference in its entirety.

### BACKGROUND

Field of Invention

The present disclosure relates to the technical field of Internet of Vehicles, and particularly relates to an image-based remote observation and alarm device and method for in-car moving objects.

Description of Related Art

With the popularization of cars, the relationship between people's life and cars becomes much closer, people stay in the cars for an increasingly long time, the running geographical range of the cars is increasingly wide, and the cars really become people's second home. However, in recent years, children are often left in the cars and die, properties in the cars are illegally stolen, etc. Among the reasons, mostly car owners cannot observe the conditions in the car in real time after leaving the cars, and when the children are left in the cars or the properties in the cars are stolen by lawbreakers, the car owners cannot be timely warned.

In the prior art, whether a moving object appears in the car is generally detected in a pressure detection manner. However, because a sensor is difficult to realize universal coverage, such a manner often results in missing detection; and on the other hand, the car owner cannot observe the car condition in real time in such a manner, so that the car owner cannot learn the specific condition in the car and cannot be effectively warned.

### SUMMARY

One or more embodiments includes an image-based remote observation and alarm device and method for in-car moving objects, which are used for solving the problems that a car owner cannot remotely observe the condition in the car in real time and cannot be timely warned after leaving a car in the prior art.

One or more embodiments includes an image-based remote observation and alarm device for in-car moving objects, including:

an image acquisition module, used for acquiring real-time scene pictures of the space inside a car to generate real-time scene image data, and transmitting the real-time scene image data to an image processing and moving object detection module;

the image processing and moving object detection module, used for performing pre-processing and moving object detection analysis on the real-time scene image data, and sending the detection result to an alarm module when detecting a moving object in the space inside the car; and

the alarm module, used for receiving the detection result sent by the image processing and moving object detection module, generating an alarm signal and transmitting the alarm signal to a networking terminal in real time.

One or more embodiments of the present disclosure provides an image-based remote observation and alarm device for in-car moving objects, including:

acquiring real-time scene pictures of the space inside a car to generate real-time scene image data;

performing pre-processing and moving object detection analysis on the real-time scene image data, and generating a detection result when detecting a moving object in the space inside the car; and

generating an alarm signal according to the detection result, and transmitting the alarm signal to a networking terminal in real time.

According to the image-based remote observation and alarm device and method for in-car moving objects in one or more embodiments, whether a moving object exists in the space inside the car can be learnt by acquiring the scene images in the space inside the car and performing moving object detection analysis on the scene images; and if a moving object is discovered, an alarm signal is generated to inform the car owner, so that the car owner can remotely observe the real scene in the car in real time at any moment and can be timely warned when a moving object is in the car, to timely take measures when a child or a pet is left in the car or the car is illegally invaded and the like.

### BRIEF DESCRIPTION OF THE DRAWINGS

In order to describe the technical solutions in the embodiments of the present disclosure or in the prior art more clearly, a simple introduction on the accompanying drawings which are needed in the description of the embodiments or the prior art is given below. Apparently, the accompanying drawings in the description below are merely some of the embodiments of the present disclosure, based on which other drawings may be obtained by those of ordinary skill in the art without any creative effort.

FIG. 1 is a structural schematic diagram of an image-based remote observation and alarm device for in-car moving objects in one or more embodiments of the present disclosure;

FIG. 2 is a structural schematic diagram of an embodiment of the image-based remote observation and alarm device for in-car moving objects in one or more embodiments of the present disclosure;

FIG. 3 is a flow diagram of an image-based remote observation and alarm method for in-car moving objects in one or more embodiments of the present disclosure;

FIG. 4 is a flow diagram of an embodiment of the image-based remote observation and alarm method for in-car moving objects in one or more embodiments of the present disclosure;

FIG. 5 is a flow diagram of another embodiment of the image-based remote observation and alarm method for in-car moving objects in one or more embodiments of the present disclosure.

### DETAILED DESCRIPTION

To make the objectives, technical solutions and advantages of the embodiments of the present disclosure clearer, a clear and complete description of the technical solutions of the embodiments of the present disclosure will be given below, in combination with the accompanying drawings in the embodiments of the present disclosure. Apparently, the embodiments described below are merely a part, but not all, of the embodiments of the present disclosure. Other variations and combinations apparent from the embodiments of the present disclosure fall into the protection scope of the present disclosure.

The embodiments of the present disclosure provide an image-based remote observation and alarm device and method for in-car moving objects. The device and the method can be applied to the space inside a car; after the car owner leaves the car, the car is in a non-supervision state; moreover, the condition in the closed car space is unlikely to discover. According to the device and the method provided by the embodiments of the preset invention, the car owner can remotely observe the space inside the car by acquiring the scene pictures of the space inside the car, meanwhile, moving object detection analysis is performed on the acquired scene image data, and an alarm signal is timely sent to the car owner when a moving object is discovered, so that the car owner can learn the accident of the space inside the car at the first time and handle with the accident in time.

In addition, the device can also be used in other spaces needing to perform remote observation and acquire alarm signals besides the space inside the car, which is not limited herein.

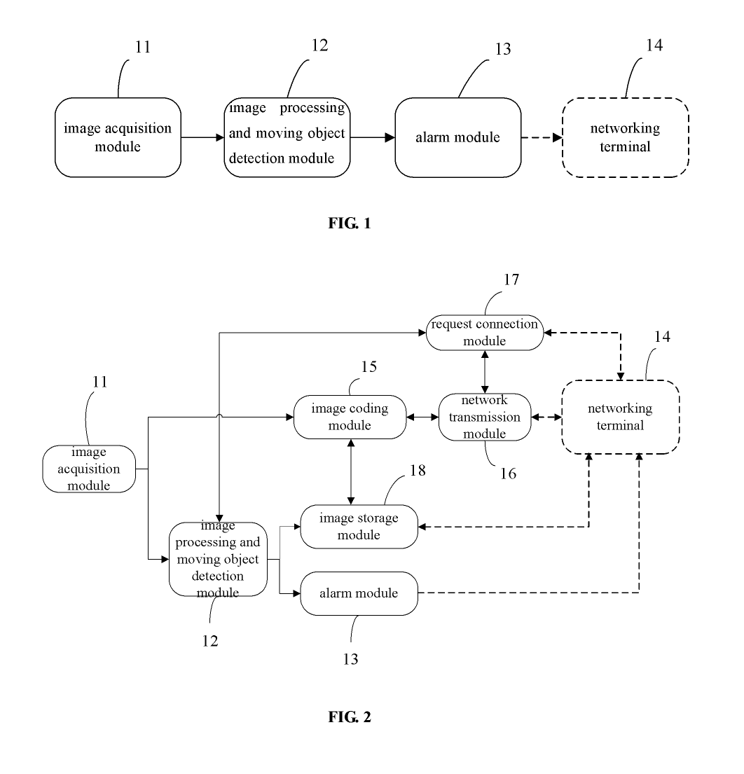

As shown in FIG. 1, an image-based remote observation and alarm device for in-car moving objects, provided by an embodiment of the present disclosure, includes an image acquisition module 11, an image processing and moving object detection module 12 and an alarm module 13.

The image acquisition module 11 communicates with the image processing and moving object detection module 12, and is used for acquiring real-time scene pictures of the space inside a car to generate real-time scene image data, and transmitting the real-time scene image data to the image processing and moving object detection module 12. The image acquisition module 11 can be connected with one or more cameras, and the cameras may be installed at appropriate positions in a car according to user needs, e.g., the car roof, windshields or other positions. The real-time scene image data are sequentially generated according to the scene pictures continuously shot by the cameras, the image acquisition module 11 can respectively generate real-time scene image data for the scene picture acquired by each camera, and preferably, the plurality of real-time scene image data are synchronous; and single real-time scene image data or the plurality of synchronous real-time scene image data can be provided to the car owner according to the need of the car owner to view remotely.

The image processing and moving object detection module 12 is used for performing pre-processing and moving object detection analysis on the real-time scene image data, and sending the detection result to the alarm module 13 when detecting a moving object in the space inside the car.

Such parameters as light, noise and the like in the car are different from one another at different time or in different scenes, so in order to avoid the influence of these parameters on the scene images acquired by the image acquisition module, the image processing and moving object detection module 12 may perform pre-processing on the scene images before moving object detection analysis, including image de-noising, image enhancement, image distortion removal, image geometric transformation and the like, which are not limited herein, thereby eliminating irrelevant information in the scene images, recovering useful real information, enhancing the detectability of relevant information and furthest simplifying data, to provide reliable basic images to the moving object detection analysis.

After the device is started, the image processing and moving object detection module detects whether the scene image includes a moving object by adopting a moving object detection algorithm, and the specific algorithm process is as follows:

Algorithm 1: a background difference method for detecting a moving object, wherein the specific flow includes background modeling, background difference extraction of a foreground image and moving object detection in the foreground image. In this process, the background model is updated in real time over time. The background modeling method may be a common one such as an average background method, a mixed Gaussian model method, a codebook method and the like; and the moving object detection method is to analyze the area, the shape and the like of connected areas in the foreground image, so as to eliminate noise interference and detect the accurate moving object.

Algorithm 2: a frame difference method for detecting a moving object, wherein if the moving object exists in a scene picture, the foreground image including the moving object can be differentiated by using the frame difference method, and then the moving object foreground image is analyzed to detect the moving object in the scene picture.

Algorithm 3: an optical flow method for detecting a moving object, wherein the optical flow of the scene image data is calculated and analyzed to detect the moving object.

The moving object detection algorithm adopted by the image processing and moving object detection module can be selected according to the practical scene, and is not limited to the above specific algorithms provided by the embodiments of the present disclosure.

When the moving object in the car is detected, a detection result is generated; the detection result may include such detection information as the number of the moving object, the time of discovering the moving object and the like; and the detection result is transmitted to the alarm module 13 in real time.

The alarm module 13 is used for receiving the detection result sent by the image processing and moving object detection module 12, generating an alarm signal and transmitting the alarm signal to a networking terminal 14 in real time. According to the above detection result, the alarm module 13 transmits the alarm signal carrying the detection information to the networking terminal 14 in real time; the networking terminal 14 may be one or more, which is not limited by the embodiments of the present disclosure; and the networking terminal 14 produces an alarm sound after receiving the alarm signal or acquires the scene images through a network and presents the scene images on a terminal screen thereof, so that a user can learn the real condition of the moving object in the car and make treatment and judgment. The alarm signal may be a car body alarm signal in one or more forms of sound, light and electricity, or a remote notification signal in one or more forms of push message, short message, call and the like.

It should be noted that, although the networking terminal 14 is marked in both FIG. 1 and FIG. 2, the networking terminal 14 does not belong to a part of the image-based remote observation and alarm device for in-car moving objects in the embodiment of the present disclosure, and is marked in the figures only for showing the transmission process of data more clearly.

The image acquisition module 11 included in the image-based remote observation and alarm device for in-car moving objects will be described below with an embodiment.

As shown in FIG. 1 or FIG. 2, the real-time scene pictures acquired by the image acquisition module 11 comprehensively cover the space inside the car, thus ensuring that the car owner can comprehensively observe the scene in the car. According to the shooting range of each camera, the cameras are arranged at appropriate positions, e.g., a single fish-eye lens is installed at the car roof or a plurality of common cameras are installed at appropriate positions, thus ensuring that the pictures shot by the cameras can comprehensively cover the space inside the car. For example, a shooting dead angle may exist between the adjacent cameras, and a camera may be arranged in the area opposite to the dead angle to acquire the image at the dead angle.

The image processing and moving object detection module 12 included in the image-based remote observation and alarm device for in-car moving objects will be described below with an embodiment.

In order to avoid the influence of the external environment on the moving object detection analysis, the image processing and moving object detection module 12 is further used for delimiting a detection area and detecting moving objects in the detection area, wherein the detection area can be delimited by a user according to the actual usage scene. For example, as moving objects outside the car may penetrate through the windows and are shot by the cameras, if the moving object detection analysis is performed on the window area, misjudgment may be caused, thus, the user can exclude such background areas as windows and the like which may cause misjudgment beyond the detection area, and then the scene influence caused by the moving objects outside the car may be avoided. In addition, the user can further delimit the detection area according to the moving object detection algorithm adopted by the image processing and moving object detection module 12, and the embodiments of the present disclosure are not limited thereto.

As shown in FIG. 2, on the basis of the device shown in FIG. 1, the image-based remote observation and alarm device for in-car moving objects, provided by the embodiments of the present disclosure, further includes:

an image coding module 15, used for coding and compressing the real-time scene image data acquired by the image acquisition module 11 or the scene image data stored by an image storage module 18, and transmitting the coded and compressed scene image data to the networking terminal 14 through a network transmission module 16; and

the network transmission module 16, used for transmitting the coded and compressed scene image data to the networking terminal 14.

As the volume of the scene image data acquired by the image acquisition module 11 is large, the image coding module 15 may code and compress the scene image data before transmission in order to adapt to the transmission protocol of the network transmission module 16 and save the network traffic.

The connection form and the connection time for communication between the image coding module 15 and the networking terminal 14 are diverse. According to the image-based remote observation and alarm device for in-car moving objects provided by the embodiments of the present disclosure, the connection time between the image coding module 15 and the networking terminal 14 is determined by a request connection module 17, and the request connection module 17 communicates with the image processing and moving object detection module 12 and the networking terminal 14, e.g., the request connection module 17 may adopt the following execution modes:

Mode 1: the request connection module 17 is used for, when the image processing and moving object detection module 12 detects the moving object in the space inside the car, actively pushing a connection request to the networking terminal 14, and after acquiring the acknowledgement of the networking terminal 14, connecting the image coding module 15 with the networking terminal 14 through the network transmission module 16 to transmit data.

Mode 2: the request connection module 17 is used for, when receiving a data acquisition request of the networking terminal 14, verifying the identity of the networking terminal 14, and if the networking terminal 14 passes the identity verification, connecting the image coding module 15 with the networking terminal 14 through the network transmission module 16 to transmit data.

Through network connection, the networking terminal 14 may present the coded and compressed scene image data in the image coding module 15 on the terminal screen thereof; however, as the volume of the scene image data is large, if the scene image data is unboundedly transmitted through a network, a large amount of network traffic may be consumed; and if the network environment of the car owner is poor or the network traffic is limited, the unbounded network connection mode is obviously improper.

According to the above mode 1, the image processing and moving object detection module 12 may generate a trigger signal when detecting a moving object, the trigger signal triggers the request connection module 17 to actively connect the image coding module 15 with the networking terminal 14, the image coding module 15 actively sends the scene image data to the networking terminal 14, and the networking terminal 14 may keep data transmission or actively disconnect the data transmission according to the viewed scene picture or the actual network condition. By such an active connection mode, the links of connection acknowledgement and the like are saved, and the car owner can observe the real condition in the car at the first time when a moving object appears in the car and make an accident judgment in time.

According to the above mode 2, the request connection module 17 plays a role in connection limitation and identity verification, so that the car owner can handle with the connection request according to actual needs; and the request connection module 17 can also verify the identity of the car owner initiating the data acquisition request, thus preventing others from illegally acquiring the scene image data. The mode 2 can be applied when the device is started or when the device is used, to control the network data transmission by the car owner.

In order to improve the autonomy of the user in the data communication process of the image coding module 15 and the networking terminal 14, so as to ensure that the user can watch the required scene picture, in another embodiment of the present disclosure:

the request connection module 17 is further used for, after the image coding module 15 is connected with the networking terminal 14, receiving a data selection instruction sent by the networking terminal 14 and transmitting the data selection instruction to the image coding module 15;

the image coding module 15 is further used for acquiring the real-time scene image data from the image acquisition module 11 or acquiring the scene image data of a designated time period from the image storage module 18 according to the data selection instruction;

wherein, the data selection instruction includes selecting the real-time scene image data generated by the image acquisition module 11 or the scene image data of the designated time period stored in the image storage module 18 according to an external input.

According to the data selection instruction input by the user, the image coding module 15 may acquire the corresponding scene image data, code and compress the scene image data and transmit the coded and compressed scene image data to the networking terminal 14. A corresponding selection interface may be set in the user interface of the networking terminal 14, and the user can input the data selection instruction to the selection interface, wherein the data selection instruction may be click or touch operation of the external input, which is not specifically limited in the present disclosure.

As shown in FIG. 2, the image-based remote observation and alarm device for in-car moving objects, provided by the embodiments of the present disclosure, further includes:

the image storage module 18, used for storing the scene image data in real time after the image processing and moving object detection module 12 pre-processes the images or marks the moving object.

The image storage module 18 stores the scene image data processed by the image processing and moving object detection module 12 in real time. The image storage module 18 is not only used for real-time storage backup of the data, but also is used for generating a historical record information list according to the attribute information of the scene image data stored in real time for user's look-up at any time, wherein the attribute information includes one or more of time information, time length information, place information, file data volume information and moving object detection result information. According to the historical record information list, the car owner can search historical records of the scene image data stored in the image storage module 18, e.g., when the car is illegally invaded and the car owner arrives at the spot, the lawbreaker may have escaped, the car owner may quickly find out the corresponding scene image data according to such attribute information as time information, place information and the like of a plurality of scene image data files stored in the image storage module 18, and submits the scene image data as proofs to assist the case trial. Wherein, the scene image data including a moving object in the historical record information list is highlighted, the scene image data including the moving object is most frequently queried by the car owner, and highlighting the scene image data can ensure that the car owner can quickly find out the required scene image data in the historical record query list according to the highlight in combination with the attribute information of the scene image data.

In order to avoid the situation that the image storage module 18 cannot store new data due to the limitation of the storage capacity, the image storage module 18 is further used for: at every preset time length or when the storage capacity thereof reaches a preset value, cleaning old data according to the attribute information of the scene image data in the historical record information list and the highlight. Particularly, according to the time information of the scene image data and the highlight, the cleaning strategy is as follows: at every preset time length or when the storage capacity thereof reaches the preset value, preferentially cleaning the early-created and/or non-highlighted scene image data; with respect to the highlighted scene image data, the validity period thereof may be preset, e.g., set to be 1 month, and after the validity period of scene image data expires, the highlight is automatically cleaned; or when the highlighted scene image data reaches a preset number, the highlight of the earliest-created scene image data is automatically cleaned, and the scene image data including the moving object becomes of the same level as the common scene image data by cleaning the highlight of the scene image data and then is cleaned.

The image-based remote observation and alarm device for in-car moving objects, provided by the embodiments of the present disclosure, may be automatically started when the car is shut down or the car doors are locked or manually started according to user needs; and after the device is started, each module runs instantaneously.

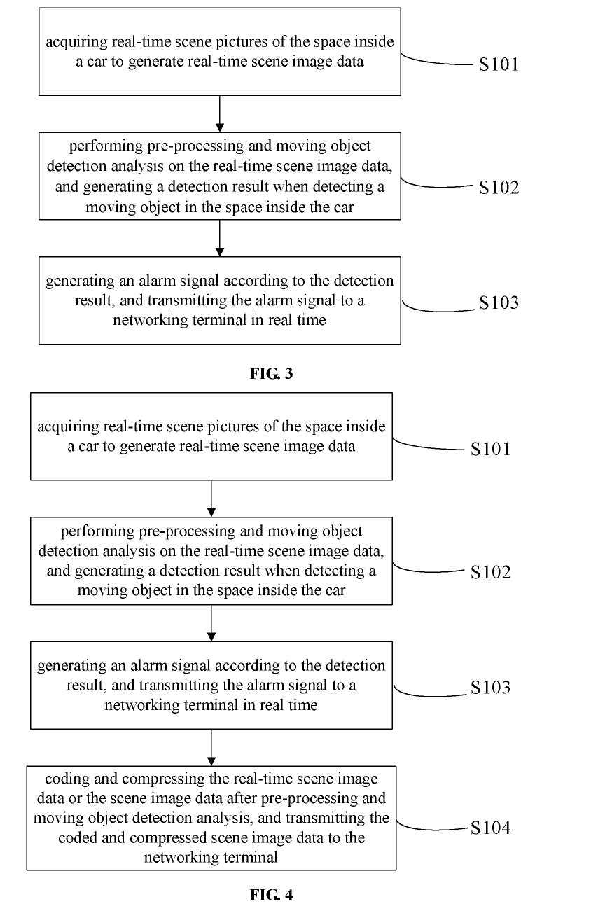

As shown in FIG. 3, the embodiments of the present disclosure further provide an image-based remote observation and alarm method for in-car moving objects, including:

S101, acquiring real-time scene pictures of the space inside a car to generate real-time scene image data;

S102, performing pre-processing and moving object detection analysis on the real-time scene image data, and generating a detection result when detecting a moving object in the space inside the car; and

S103, generating an alarm signal according to the detection result, and transmitting the alarm signal to a networking terminal in real time.

In step S101, scene images of the space inside the cars may be acquired by one or more cameras, and to acquire the scene images collected by the cameras, the cameras may be installed at appropriate positions in a car according to user needs, e.g., the car roof, windshields or other positions. The real-time scene image data are sequentially generated according to the scene images continuously shot by the cameras, the image acquisition module can respectively generate real-time scene image data for the scene image acquired by each camera, and preferably, the plurality of real-time scene image data are synchronous; and single real-time scene image data or the plurality of synchronous real-time scene image data can be provided to the car owner according to the need of the car owner to view remotely.

Such parameters as light, noise and the like in the car are different from one another at different time or in different scenes, so in order to avoid the influence of these parameters on the scene image data in step S102, step S102 further includes: performing pre-processing on the scene image data before moving object detection analysis, including image de-noising, image enhancement, image distortion removal, image geometric transformation and the like, which are not limited herein, thereby eliminating irrelevant information in the scene image data, recovering useful real information, enhancing the detectability of relevant information and furthest simplifying data, to provide reliable basic image data for the moving object detection analysis.

According to step S102, when the moving object in the car is detected, a detection result is generated, wherein the detection result may include such detection information as the number of the moving object, the time of discovering the moving object and the like.

According to the above detection result, the alarm signal carrying the detection information is transmitted to the networking terminal in real time in S103, and the networking terminal produces an alarm sound after receiving the alarm signal or acquires the scene images through a network and presents the scene images on a terminal screen thereof, so that a user can learn the real condition of the moving object in the car and make treatment and judgment. The alarm signal may be a car body alarm signal in one or more forms of sound, light and electricity, or a remote notification signal in one or more forms of push message, short message, call and the like.

Step S101 in the image-based remote observation and alarm method for in-car moving objects will be described below with an embodiment.

Step S101 further includes:

acquiring the real-time scene pictures comprehensively covering the space inside the car. According to the shooting range of each camera, the cameras are arranged at appropriate positions, e.g., a single fish-eye lens is installed at the car roof or a plurality of common cameras are installed at appropriate positions, thus ensuring that the pictures shot by the cameras can comprehensively cover the space inside the car, and then ensuring that the car owner can comprehensively observe the scene in the car.

Step S102 in the image-based remote observation and alarm method for in-car moving objects will be described below with an embodiment.

Step S102 further includes:

delimiting a detection area and detecting moving objects in the detection area. The detection area can be delimited by a user according to the actual usage scene. For example, as moving objects outside the car may penetrate through the windows and are shot by the cameras, if the moving object detection analysis is performed on the window area, misjudgment may be caused, thus, the user can exclude such background areas as windows and the like which may cause misjudgment beyond the detection area, and then the scene influence caused by the moving objects outside the car may be avoided. In addition, the user can further delimit the detection area according to the adopted moving object detection algorithm, and the embodiments of the present disclosure are not limited thereto.

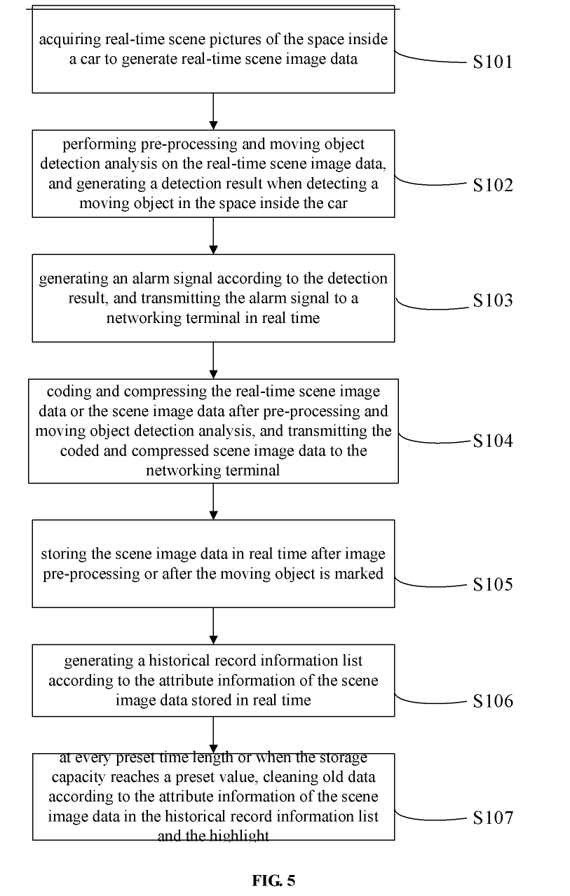

As shown in FIG. 4, on the basis of steps S101-103 shown in FIG. 3, the image-based remote observation and alarm method for in-car moving objects, provided by the embodiments of the present disclosure, further includes:

S104, coding and compressing the real-time scene image data or the scene image data after pre-processing and moving object detection analysis, and transmitting the coded and compressed scene image data to the networking terminal.

As the volume of the scene image data acquired in steps S101 and S102 is large, the scene image data may be coded and compressed before transmission in step S104 in order to adapt to the transmission protocol and save the network traffic.

In step S104, the coded and compressed scene image data is transmitted to the networking terminal in multiple possible implementation modes, e.g.:

Mode 1: when the moving object in the space inside the car is detected, a connection request is actively pushed to the networking terminal, and after the acknowledgement of the networking terminal is acquired, the coded and compressed scene image data is transmitted to the networking terminal.

Mode 2: when a data acquisition request of the networking terminal is received, the identity of the networking terminal is verified, and if the networking terminal passes the identity verification, the coded and compressed scene image data is transmitted to the networking terminal. Through network connection, the networking terminal may present the scene image data acquired in step S101 on the terminal screen thereof; however, as the volume of the scene image data is large, if the scene image data is unboundedly transmitted through a network, a large amount of network traffic may be consumed; and if the network environment of the car owner is poor or the network traffic is limited, the unbounded network connection mode is obviously improper.

According to the above mode 1, when a moving object is detected in step S102, a trigger signal may be generated; in the second mode, a network transmission channel is actively connected according to the trigger signal, and after the network transmission channel is connected, the scene images are actively sent to the networking terminal; and the networking terminal may keep data transmission or actively disconnect the data transmission according to the viewed scene images or the actual network condition. Such an active connection mode saves the links of connection acknowledgement and the like, and effectively ensures that the car owner can observe the real condition in the car at the first time when a moving object appears in the car and make an accident judgment in time, e.g., if a child is left in the car, the child serving as a moving object can trigger the connection of the network transmission channel, and the car owner is reminded at the first time of a person in the car, views the real condition in the car and arrives at the spot in time or informs people nearby of rescuing immediately.

According to the above mode 2, not only the network transmission can be connected or disconnected according to the connection request processing result of the car owner, but also the identity of the car owner initiating the data acquisition request can be verified, thus preventing others from illegally acquiring the scene image data.

It should be noted that, the first mode and the second mode are respectively applied to different application scenes, i.e., the first mode is applied to a special scene of discovering a moving object, while the second mode is applied to a common scene, so the two modes do not have an obvious sequence, and the sequence is not specifically limited by the present disclosure.

After the communication with the networking terminal is established according to the above two modes, in order to improve the autonomy of the user in the data communication process, so as to ensure that the user can watch the required scene picture, another implementation of step S104 is further provided in another embodiment of the present disclosure:

receiving a data selection instruction sent by the networking terminal, and acquiring the real-time scene image data or extracting the scene image data of a designated time period after pre-processing and moving object analysis according to the data selection instruction;

wherein, the data selection instruction includes selecting the real-time scene image data or the stored scene image data of the designated time period after pre-processing and moving object analysis according to an external input.

According to the data selection instruction input by the user, the corresponding scene image data may be acquired, coded, compressed and transmitted to the networking terminal in step S104. A corresponding selection interface may be set in the user interface of the networking terminal, and the user can input the data selection instruction into the selection interface, wherein the data selection instruction may be click or touch operation of the external input, which is not specifically limited in the present disclosure.

As shown in FIG. 5, the image-based remote observation and alarm method for in-car moving objects, provided by the embodiments of the present disclosure, further includes:

S105, storing the scene image data in real time after image pre-processing or after the moving object is marked. It should be noted that, step S105 is not limited to be executed after step S104 as shown in FIG. 5, and does not have an obvious sequence with other steps, so the solutions in which S105 is behind step 102 shall fall into the protection scope of one or more embodiments of present disclosure.

As shown in FIG. 5, the image-based remote observation and alarm method for in-car moving objects, provided by the embodiments of the present disclosure, can not only execute real-time storage backup of data, but also can execute:

S106, generating a historical record information list according to the attribute information of the real-time stored scene image data for user's look-up at any time, wherein the attribute information includes one or more of time information, time length information, place information and file data volume information. According to the historical record information list, the car owner can search historical records of the scene image data stored in S105, e.g., when the car is illegally invaded and the car owner arrives at the spot, the lawbreaker may have escaped, the car owner may quickly find out the corresponding scene image data according to such attribute information as time information, place information and the like of a plurality of scene image data in the historical record query list, and submits the scene image data as proofs to assist the case trial. Wherein, the scene image data including a moving object in the historical record information list is highlighted, the scene image data including the moving object is most frequently queried by the car owner, and highlighting the scene image data can ensure that the car owner can quickly find out the required scene image data in the historical record query list according to the highlight in combination with the attribute information of the scene image data.

In order to avoid the situation that new data cannot be stored due to the limitation of the storage capacity in S105, the image-based remote observation and alarm method for in-car moving objects, provided by the embodiments of the present disclosure, further includes:

S107, at every preset time length or when the storage capacity reaches a preset value, cleaning old data according to the attribute information of the scene image data in the historical record information list and the highlight. Particularly, according to the time information of the scene image data and the highlight, the cleaning strategy is as follows: at every preset time length or when the storage capacity reaches the preset value, preferentially cleaning the early-created and/or non-highlighted scene image data; with respect to the highlighted scene image data, the validity period thereof may be preset, e.g., set to be 1 month, and after the validity period of the scene image data expires, the highlight is automatically cleaned; or when the highlighted scene image data reaches a preset number, e.g., when the total storage capacity is 16 G, a single scene image is about 500M and the number of the highlighted scene image data reaches 10, the highlight of the earliest-created scene image data is automatically cleaned, and the scene image data including the moving object becomes of the same level as the common scene image data by cleaning the highlight of the scene image data and then is cleaned according to the creation time.

It should be noted that, the old data cleaning process of step S107 is not limited to be executed after step S106 as shown in FIG. 5, i.e., the storage capacity can be monitored in real time, and the old data is cleaned at every preset time length or when the storage capacity reaches the preset value.

According to the image-based remote observation and alarm device and method for in-car moving objects, provided by the embodiments of the present disclosure, firstly, comprehensive scene image data in the space inside the car can be acquired, the real condition in the car can be observed in real time through the networking terminal after the car owner leaves the car, and an alarm is given in time when a moving object exists in the car; secondly, the car owner can selectively acquire the scene image data according to actual needs, so that the autonomy of the user is ensured and the network traffic consumption caused by unbounded connection can be avoided, and the identity of the user requiring acquiring data can be verified to ensure the information security; thirdly, storage backup and historical record query functions are further provided, to ensure that the car owner can conveniently and quickly find out the required scene image data, particularly the scene image data including moving objects; moreover, an automatic cleaning function is further provided to ensure the storage space of new data, and the storage time of the scene image data including the moving objects is greatly prolonged to ensure that the scene image data including the moving objects as legal evidence is not destroyed within a short time.

In addition, the embodiments of the present disclosure further provide an image-based remote observation and alarm system for in-car moving objects, including the image-based remote observation and alarm device for in-car moving objects as shown in FIG. 1 or FIG. 2 and a networking terminal, wherein the networking terminal is used for receiving alarm signals and scene images sent by the image-based remote observation and alarm device for in-car moving objects, decompressing and playing the scene images and the like. The networking terminal can communicate with the image-based remote observation and alarm device for in-car moving objects only by installing a corresponding App. The networking terminal may be such PDA (Personal Digital Assistant) equipment as a mobile phone and the like, which is not limited in the present disclosure.

One or more embodiments of the present disclosure further provides an image-based remote observation and alarm device for in-car moving objects, comprising: a processor; and a memory for storing instructions executable by the processor; wherein the processor is configured to: acquire real-time scene pictures of the space inside a car to generate real-time scene image data; perform pre-processing and moving object detection analysis on the real-time scene image data, and generate a detection result when detecting a moving object in the space inside the car; generate an alarm signal according to the detection result, and transmit the alarm signal to a networking terminal in real time, wherein the real-time scene pictures comprehensively cover the space inside the car, wherein the processor is further configured to delimit a detection area and detect moving objects in the detection area, wherein the processor is further configured to code and compress the real-time scene image data or the scene image data after pre-processing and moving object detection analysis, and transmit the coded and compressed scene image data to the networking terminal, wherein the processor is further configured to: when a moving object in the space inside a car is detected, actively push a connection request to the networking terminal, and after acquiring the acknowledgement of the networking terminal, transmit the coded and compressed scene image data to the networking terminal, or when receive a data acquisition request of the networking terminal, verify the identity of the networking terminal, and if the networking terminal passes the identity verification, transmit the coded and compressed scene image data to the networking terminal, wherein the processor is further configured to: receive a data selection instruction sent by the networking terminal, and acquire the real-time scene image data or extract the scene image data of a designated time period after pre-processing and moving object analysis according to the data selection instruction; wherein, the data selection instruction comprises selecting the real-time scene image data or the stored scene image data of the designated time period after pre-processing and moving object analysis according to an external input, wherein the processor is further configured to: store the scene image data in real time after image pre-processing or after the moving object is marked; wherein, the image pre-processing comprises one or more of image de-noising, image enhancement, image distortion removal and image geometric transformation, wherein the processor is further configured to: generate a historical record information list according to the attribute information of the scene image data stored in real time, wherein the scene image data comprising a moving object in the historical record information list is highlighted; and the attribute information comprises one or more of time information, time length information, place information, file data volume information and moving object detection result information, wherein the processor is further configured to: at every preset time length or when the storage capacity reaches a preset value, clean old data according to the attribute information of the scene image data in the historical record information list and the highlight, wherein the alarm signal is a car body alarm signal in one or more forms of sound, light and electricity, or a remote notification signal in one or more forms of push message, short message and call.

The embodiments of the above-described devices are only exemplary, wherein the units illustrated as separate components may be or may not be physically separated, and the components displayed as units may be or may not be physical units, that is to say, the components may be positioned at one place or may also be distributed on a plurality of network units. The objectives of the solutions of the embodiments may be fulfilled by selecting part or all of the modules according to actual needs. Those of ordinary skill in the art could understand and implement the embodiments without any creative effort.

Through the descriptions of the above embodiments, those skilled in the art could clearly learn that each embodiment may be realized by means of software and a necessary general hardware platform, and of course, may be realized by hardware. Based on such a understanding, the above technical solutions substantially or the part making contribution to the prior art may be embodied in the form of a software product, and the computer software product is stored in a computer readable storage medium, such as an ROM (Read-Only Memory)/RAM (Random Access Memory), a disk, an optical disk and the like, which includes a plurality of instructions enabling computer equipment (which may be a personal computer, a server, or network equipment and the like) to execute each embodiment or the method at some part of each embodiment.

Finally, it should be noted that, the above embodiments are merely used for illustrating the technical solutions of the present disclosure, rather than limiting the present disclosure; though the present disclosure is illustrated in detail with reference to the aforementioned embodiments, it should be understood by those of ordinary skill in the art that modifications may still be made on the technical solutions disclosed in the aforementioned respective embodiments, or equivalent alterations may be made to part of technical features thereof; and these modifications or alterations do not make the nature of the corresponding technical solutions depart from the spirit and scope of the technical solutions of the respective embodiments of the present disclosure.

What is claimed is:

1. An image-based remote observation and alarm device for in-car moving objects, comprising:
a processor; and
a memory for storing instructions executable by the processor,
wherein the processor is configured to:
acquire real-time scene pictures of a space inside a car to generate real-time scene image data;
perform pre-processing and moving object detection analysis on the real-time scene image data, and generate a detection result when detecting a moving object in the space inside the car;
generate an alarm signal according to the detection result; and
transmit the alarm signal to a networking terminal in real time.

2. The device of claim 1, wherein the real-time scene pictures comprehensively cover the space inside the car.

3. The device of claim 1, wherein the processor is further configured to delimit a detection area and detect the moving objects in the detection area.

4. The device of claim 1, wherein the processor is further configured to:
code and compress the real-time scene image data or scene image data after pre-processing and the moving object detection analysis; and
transmit the coded and compressed scene image data to the networking terminal.

5. The device of claim 4, wherein the processor is further configured to:
when the moving object in the space inside the car is detected, actively push a connection request to the networking terminal, and after acquiring the acknowledgement of the networking terminal, transmit the coded and the compressed scene image data to the networking terminal, or when receiving a data acquisition request of the networking terminal, verify the identity of the networking terminal, and if the networking terminal passes the identity verification, transmit the coded and the compressed scene image data to the networking terminal.

6. The device of claim 5, wherein the processor is further configured to:
receive a data selection instruction sent by the networking terminal, and acquire the real-time scene image data or extract the scene image data of a designated time period after pre-processing and the moving object detection analysis according to the data selection instruction,
wherein, the data selection instruction comprises selecting the real-time scene image data or the stored scene image data of the designated time period after pre-processing and the moving detection object analysis according to an external input.

7. The device of claim 1, wherein the processor is further configured to:
store the scene image data in real time after image pre-processing or after the moving object is marked,
wherein, the image pre-processing comprises one or more of image de-noising, image enhancement, image distortion removal or image geometric transformation.

8. The device of claim 7, wherein the processor is further configured to:
generate a historical record information list according to the attribute information of the scene image data stored in real time, wherein the scene image data comprising the moving object in the historical record information list is highlighted; and
the attribute information comprises one or more of time information, time length information, place information, file data volume information or moving object detection result information.

9. The device of claim 8, wherein the processor is further configured to: at every preset time length or when the storage capacity reaches a preset value, clean old data according to the attribute information of the scene image data in the historical record information list and the highlight.

10. The device of claim 1, wherein the alarm signal is a car body alarm signal in one or more forms of sound, light and electricity, or a remote notification signal in one or more forms of push message, short message and call.

11. An image-based remote observation and alarm device for in-car moving objects, comprising:
acquiring real-time scene pictures of a space inside a car to generate real-time scene image data;
performing pre-processing and moving object detection analysis on the real-time scene image data, and generating a detection result when detecting a moving object in the space inside the car;
generating an alarm signal according to the detection result; and
transmitting the alarm signal to a networking terminal in real time.

12. The method of claim 11, wherein acquiring real-time scene pictures of the space inside the car to generate real-time scene image data comprises:
the real-time scene pictures comprehensively cover the space inside the car.

13. The method of claim 11, wherein performing pre-processing and the moving object detection analysis on the real-time scene image data comprises:
delimiting a detection area and detecting the moving objects in the detection area.

14. The method of claim 11, further comprising:
when communicating with the networking terminal, coding and compressing the real-time scene image data or the scene image data after pre-processing and the moving object detection analysis; and transmitting the coded and compressed scene image data to the networking terminal.

15. The method of claim 14, wherein transmitting the coded and compressed scene image data to the networking terminal comprises:
when the moving object in the space inside the car is detected, actively pushing a connection request to the networking terminal, and after acquiring the acknowledgement of the networking terminal, transmitting the coded and compressed scene image data to the networking terminal, or when receiving a data acquisition request of the networking terminal, verifying the identity of the networking terminal, and if the networking terminal passes the identity verification, transmitting the coded and compressed scene image data to the networking terminal.

16. The method of claim 15, wherein transmitting the coded and compressed scene image data to the networking terminal further comprises:
receiving a data selection instruction sent by the networking terminal, and acquiring the real-time scene image data or extracting the scene image data of a designated time period after pre-processing and the moving object detection analysis according to the data selection instruction,
wherein, the data selection instruction comprises selecting the real-time scene image data or the stored scene image data of the designated time period after pre-processing and the moving object detection analysis according to an external input.

17. The method of claim 11, further comprising:
storing the scene image data in real time after image pre-processing or after the moving object is marked,
wherein, the image pre-processing comprises one or more of image de-noising, image enhancement, image distortion removal or image geometric transformation.

18. The method of claim 17, further comprising:
generating a historical record information list according to the attribute information of the scene image data stored in real time, wherein the scene image data comprising the moving object in the historical record information list is highlighted; and the attribute information comprises one or more of time information, time length information, place information, file data volume information or moving object detection result information.

19. The method of claim 18, further comprising:
at every preset time length or when the storage capacity reaches a preset value, cleaning old data according to the attribute information of the scene image data in the historical record information list and the highlight.

20. The method of claim 11, wherein the alarm signal is a car body alarm signal in one or more forms of sound, light and electricity, or a remote notification signal in one or more forms of push message, short message and call.
